(19) United States
(12) Patent Application Publication
(10) Pub. No.: US 2022/0016781 A1
(43) Pub. Date: Jan. 20, 2022

(54) Method for Aligning a Robotic Arm

(71) Applicant: Rethink Robotics GmbH, Bochum (DE)

(72) Inventors: Christian Bachmann, Munchen (DE); Dominik Bergmann, Sachsenkam (DE); Mirjam Mantel, Haar (DE); Christian Mose, Munchen (DE); Guillaume Pais, Munchen (DE)

(21) Appl. No.: 17/377,707

(22) Filed: Jul. 16, 2021

(30) Foreign Application Priority Data
Jul. 17, 2020 (DE) 102020208961.2

(51) Int. Cl. B25J 9/16; B25J 17/00; B25J 9/10

(52) U.S. Cl. CPC B25J 9/1692; B25J 9/10; B25J 17/00

(57) ABSTRACT

A method for aligning a robotic arm in a superordinate reference pose is specified, —where the robotic arm includes a plurality of robotic joints, each of which includes a drive device which enables rotation about an associated axis of rotation, where an associated eccentric lever element is formed for at least two selected robotic joints by one or more other partial elements of the robotic arm, the method including: aligning the drive device of a first selected robotic joint in an automated manner in a first target position in which the associated first eccentric lever element is disposed in a reversal position, aligning the drive device of a second selected robotic joint in an automated manner in a second target position in which the associated second eccentric lever element is disposed in a reversal position, where the sub-steps are repeated in an iterative loop until the change in angle effected in each sub-step falls below a predetermined limit value.

### CROSS-REFERENCE TO RELATED APPLICATIONS

This application claim priority to German Application No. 102020208961.2, filed Jul. 17, 2020, which is incorporation herein by specific reference.

### BACKGROUND OF THE INVENTION

### 1. The Field of the Invention

The present invention relates to a method for aligning a robotic arm in a superordinate reference pose, where the robotic arm comprises a plurality of robotic joints, each of which comprises a drive device that enables rotation about an associated axis of rotation.

### 2. The Relevant Technology

Multi-axis robotic arms are basically known from prior art. Robotic arms with six or seven rotary drives are often used for industrial applications, as the high number of degrees of freedom enables very flexible positioning. Due to the relatively large number of degrees of freedom of motion of such multi-axis robotic arms, it is often relatively complex to achieve absolute calibration of the angular positions that can set by the individual robotic joints and thereby calibration of the absolute pose of an end effector attached to the outermost joint. In order to achieve precise, absolute positioning with the robotic arm, however, it is necessary to know the alignment of the individual joints relative to one another as precisely as possible. This can basically be achieved by integrating rotary position sensors into the individual robotic joints and by calibrating as precisely as possible the angular positions measured with these rotary position sensors. If something changes in the absolute installation positions of the individual joint drives during the operating time of the robotic arm, however, then the absolute angle calibration of all individual joints may have to be repeated. Especially when external sensors and/or manual measurement measures are used to calibrate the absolute angle with regard to all existing degrees of freedom, such a method turns out to be relatively complex.

There is therefore a fundamental need to be able to align a robotic arm in a predetermined superordinate reference pose as simply and automated as possible for all rotary joints without an externally performed angle calibration. From this superordinate reference pose, other defined poses could then also be set precisely by defined relative changes in angle.

### SUMMARY OF THE INVENTION

The object of the invention is therefore to provide a method for aligning a multi-axis robotic arm in a superordinate reference pose with which the reference pose can be obtained with high positional accuracy and in a simple manner. In particular, it is to be possible to carry out this method in an automated manner and without the use of external sensors.

This object is satisfied by the method described in the claims. The method is used to align a robotic arm in a superordinate reference pose This robotic arm comprises a plurality of robotic joints, each of which comprises a drive device which enables rotation about an associated axis of rotation. Where an associated eccentric lever element is formed for at least two selected robotic joints by one or more other partial elements of the robotic arm. The method comprises the following sub-steps:
i) aligning the drive device of a first selected robotic joint in an automated manner in a first target position in which the associated first eccentric lever element is disposed in a reversal position,
ii) aligning the drive device of a second selected robotic joint in an automated manner in a second target position in which the associated second eccentric lever element is disposed in a reversal position.

These two sub-steps i) and ii) are repeated in an iterative loop one after the other until the change in angle effected in each sub-step falls below a predetermined limit value.

The automated alignment of a multi-axis robotic arm is therefore described. The “superordinate reference pose” is to be understood to be a target arrangement of this multi-axis robotic arm in which at least a subset of the robotic joints is made to assume a predetermined angular position. In general, a pose is understood in robotics to be the combination of position and orientation of an object. The essential part of a robotic arm that is to be positioned and oriented is typically an end effector which is connected to the outermost joint (as viewed from a base). In the context of the present method, the reference pose should not only be understood to mean a predetermined position and orientation of the end effector, but a predetermined angular position for each one of the “selected robotic joints”. The geometry parameters should be completely determined at least for these selected joints since a pose of the end effector can under certain circumstances in fact be obtained through various combinations of settings.

The “selected robotic joints” are presently to be understood to be a subset of the total robotic joints present—namely all those joints whose angular position is precisely defined within the framework of the superordinate reference pose. Accordingly, only these “selected robotic joints” need to be aligned using the method according to the invention. The other robotic joints (if any), on the other hand, can assume any angular position also in the superordinate reference position. They are therefore also freely variable within the reference position or they are not necessarily made to assume a predefined angular position, at least when the method according to the invention is executed. However, the angular positions of these “non-participating” joints should not be changed while performing the method.

At least a predominant number of the existing robotic joints is advantageously aligned in a predefined angular position within the framework of the reference pose. This applies above all to those joints with which vertical alignment of the neighboring links is made possible.

An “eccentric lever element” is presently understood to mean an element which is arranged eccentrically with respect to the respective axis of rotation of the joint under consideration. In other words, its center of mass should be spaced from the relevant axis of rotation. In this way, the eccentric lever element acts as a lever under the influence of gravity, so that it can create a torque in the region of the output member as a function of angular positions. This eccentric lever element is formed by one or more other partial elements of the robotic arm. In particular, the lever element can respectively be formed by robotic joints and/or robotic links located further outwardly (i.e., more distant from a base), possibly in combination with a tool of an end effector. In this way, the lever element required for the automated alignment method is already formed by existing elements of the robotic arm, at least for the selected robotic joints, and does not have to be added for calibration.

Due to the influence of gravity and depending on its angular position relative to the central axis, the eccentric lever element can exert a torque, the effect of which can also be measured within the drive device. In order to achieve this, the relevant axis of rotation expediently has at least one directional component perpendicular to the gravitational vector. It is particularly advantageous to have the axes of rotation of the selected robotic joints be oriented substantially perpendicular to the gravitational vector, at least in the superordinate reference pose (i.e., the target state), meaning, they are disposed horizontally in space. At the beginning of the automated alignment process as well, it is advantageous to have the axes of rotation of the selected joints enclose an angle of 45° or more with the gravitational vector in order to enable the individual joints to be aligned according to the individual sub-steps from the outset.

The “reversal position” mentioned can be in particular an upper reversal position. The eccentric lever element of the joint under consideration is then aligned in such a way that its center of mass lies vertically exactly above the axis of rotation under consideration. The center of mass should therefore be disposed geodetically higher than the axis of rotation. In principle, however, the reversal position can also be an underneath reversal position in which the center of mass lies vertically exactly below the axis of rotation under consideration. In any case, the gravitational force acting upon the center of mass in the reversal position should act exactly in the direction of the axis of rotation so that no torque due to the force of gravity acts with respect to this axis of rotation.

The method according to the invention for aligning the robotic arm uses the knowledge that the zero-crossing in the torque of the lever arm can be detected in an automated manner. For this purpose, at least the “selected robotic joints” can be provided with a measuring device with which the reversal position is detected. This measuring device can be based (directly or indirectly) on a measurement of the torque upon the lever element caused by the action of gravity. If such a measurement can be automated, then automated alignment of the lever element in the reversal position is also possible.

The method according to the invention for aligning the robotic arm in the superordinate reference pose is based on the knowledge that not only individual joints, but under certain circumstances also the entire robotic arm or at least a plurality of selected joints can be aligned one after the other by rotating the lever to the reversal position. If this iterative loop is repeated frequently enough for at least two selected joints, then a very precise and, above all, autonomous vertical extension of the robotic arm can be achieved overall. The iterative loop is necessary for the reason that the center of gravity of the eccentric lever element effective for the inner joints is changed in order to change the alignment in the more outwardly parts of the robotic arm. By changing the pose “further outwardly”, renewed actuation of the resulting new reversal position of the lever element is therefore necessary for the inner links. If the alternating actuation of the respective reversal position is repeated frequently enough, then the most vertically extended pose can be assumed with an iterative method with relatively high accuracy.

This autonomous alignment in the superordinate reference pose can be achieved with comparatively little expenditure on equipment, since determining the reversal positions is possible with comparatively simple measuring devices, as shall be explained in more detail below. The time required for this self-alignment is also advantageously little, since each sub-step for an automated execution (e.g., by way of an automated control device within the respective drive device) requires very little time. Simple and precise self-adjustment of the robotic arm with respect to several joints is made possible in this manner, which can in particular be carried out without external sensors and without human interaction.

The accuracy of this self-adjustment depends on the selection of the predetermined limit values. In principle, these limit values can be selected to be either the same or different for the individually selected joints. The limit value for the change in angle can be selected to be particularly low, in particular where the influence of the angle setting on the alignment and position of the end effector is particularly great for a given joint. Due to the propagation of inaccuracies from the inside to the outside, this is typically the case in particular for joints close to the base. In general, the accuracy obtained can therefore be set by selecting the setting of the limit values.

Advantageous configurations and developments of the invention arise from the claims that are dependent on claim 1 and the subsequent description.

The drive devices of the at least two selected robotic joints can each comprise an electric drive machine. They can also each comprise an output member which is rotatable relative to the associated axis of rotation by way of the drive machine. Furthermore, they can each comprise a current sensor for measuring an operating current flowing within the electric drive machine.

According to a particularly preferred embodiment of the method, the automated alignment in the first target position can be effected for each of these drive devices of the “selected robotic joints” by the following sub-steps:
a) successively actuating a plurality of predetermined angular positions of the output member,
b) measuring an associated current value for each predetermined angular position by way of the current sensor,
c) determining a target position from the pair of values thus determined, such that the associated current value of the target position comes as close as possible to a zero-crossing.

This embodiment makes use of the fact that there are current sensors present anyway in many drive devices for measuring the operating current flowing in the drive machine. In any case, such current sensors can be integrated very easily into such a drive device. The eccentric lever element at least in certain angular positions generates a torque which is transmitted to the region of the drive machine via the output member and typically a drive shaft (possibly via an interposed gear unit). The torque of the lever element can therefore also exert influence upon the operating mode of the drive machine. There are two possible operating states for the operation of the electric drive machine: It can be operated either in “motor mode” or in “generator mode”. In motor mode, the machine works against the force of gravity acting upon the lever element and rotates the lever element in the direction of a reversal position. Electrical energy must be used for this. In the generator mode, the machine works in the direction of the force of gravity acting upon the lever element and turns the lever element towards the lower reversal position. Electrical energy can then be generated. The torque caused by the lever element becomes zero both in the upper reversal position as well as in the lower reversal position, and there is a zero-crossing of electrical energy used or generated in these regions. This zero-crossing can be determined by way of a zero-crossing of the current value measured. The electrical machine can be operated, for example, with three-phase alternating current. For example, the amplitude of the phase current (A_peak) of the machine current can be measured as the current value.

The electrical machine can comprise a rotor and a stator. For example, the operating current can be the current flowing in an armature winding, where the armature winding can in principle be arranged within the stator or also within the rotor. Other types of machines can basically also be used in which the type of current measurement can also be carried out differently. In the context of the present embodiment, it is only essential that the change between the motor mode and the generator mode taking place in the reversal positions of the lever lead to a reversal in the sign of the current value measured.

As part of the alignment process, the relevant target position is determined in each sub-step as that position of the lever element in which the current value measured comes as close as possible to a zero-crossing. In general, this upper or lower reversal position can be determined by moving to the angular positions once or several times and measuring the associated current values. The association of a zero-crossing measured to an upper reversal position can generally be derived from the direction of the reversal of the sign, since a change from the motor mode to the generator mode always takes place when this position is passed, regardless of the direction of rotation. On the other hand, when passing through the lower reversal position, the opposite is true. With a correspondingly high accuracy of the measurement of the current zero point, the respective reversal position for the given “selected joint” can be found very precisely in a very simple manner and with measurement technology that is typically already present. The target position of the lever element respectively under consideration is determined in relation to the absolute position of the gravitational vector in space.

Further advantages, features, and configuration variants of this preferred embodiment with current measurement are described in the application with the title “Verfahren zur Winkelpositions-Kalibrierung, Antriebseinrichtung und Roboterarm (Method for angular position calibration, drive device and robotic arm)” filed by the same applicant and on the same date of filing. The disclosure content of this parallel application is therefore to be incorporated into the present application.

According to an advantageous variant of the embodiment with current measurement, step a) can each have the following sub-steps:
a1) successively actuating a first sequence of predetermined angular positions such that the output member is continuously rotated in a fixed first direction of rotation,
a2) successively actuating a second sequence of predetermined angular positions such that the output member is continuously rotated in an oppositely directed second direction of rotation,

In step c), a first reference angle can be determined from the pairs of values of the first sequence determined, and a second reference angle can be determined from the pairs of values of the second sequence determined. A superordinate target position for the lever element of the respective currently selected robotic joint can then be determined by averaging the first and the second reference angles. In other words, the hysteresis effects occurring during the measurement can be corrected out by averaging the zero-crossing angles for a forward direction and a reverse direction, as is described in more detail in the application filed in parallel. As a result, the respective reversal position can be determined even more precisely than with a single run of the current measurement as a function of the angular position.

Generally advantageously, the total number of robotic joints can be between 3 and 7. Even if the iterative method according to the invention can already be used with a two-axis robotic arm, the advantages of the autonomous alignment are particularly evident with such higher-axis robotic arms: Due to the complexity of such multi-axis robotic arms, the alignment in a superordinate reference pose becomes increasingly difficult with an increasing number of axes. The advantages of precise, automated alignment, which does not require any additional external sensors, take all the more effect. Nowadays, 6 or 7-axis robotic arms are used for many industrial tasks. However, not all of these robotic joints have to be so-called selected robotic joints in the sense of the method according to the invention. It is basically sufficient also with the multi-axis robotic arms if two joints are iteratively aligned as “selected robot joints”.

With such a multi-axis robotic arm, however, three or more selected robotic joints are aligned particularly advantageously with the method described. For a number n of three or more selected robotic joints, an associated eccentric lever element can respectively be formed by one or more other partial elements. The method can then comprise an iterative loop in which the following sub-step is carried in each run of the loop out one after the other for all n selected robotic joints:
s-i) aligning the drive device of the respective selected robotic joint in an automated manner in an associated target position in which the associated eccentric lever element is disposed in a reversal position.

This loop is to be run until the change in angle effected in each sub-step falls below a predetermined limit value.

“i” is to designate the index of the respective sub-step s-i and run from 1 to n over all selected robotic joints. Where sub-step i) mentioned in claim 1 corresponds to sub-step s-1) and the sub-step ii) mentioned in claim 1 corresponds to sub-step s-2) in the more general formulation. The total number of partial steps in a run of the loop is n. In this embodiment, the iterative automated alignment of two selected robotic joints is expanded to three or more.

According to a first configuration variant of the iterative loop, the sequence in which the individual selected robotic joints are aligned can run continuously from the outside to the inside during each run of the loop. The inner joints are presently to be understood generally to mean those joints which are closer to a base of the robotic arm, and the outer joints are to be understood to mean those joints which are closer to an end effector of the robotic arm. The outer joints are then first extended, and the joints further inwardly are then extended. Thereafter, extending the outer joints is repeated, and the inner joints are adjusted with their renewed extension to the new position of the outer joints (and the resulting changed center of gravity of the lever element formed). Especially if the links located further outwardly (i.e., the linkages between the individual robotic joints) are formed to be smaller and lighter than the links further inwardly, this iterative approach from the outside to the inside can lead relatively quickly to a convergence of the superordinate pose.

According to a second configuration variant of the iterative loop, the sequence in which the individual selected robotic joints are aligned can alternatively run continuously from the inside to the outside during each run of the loop. Depending on the exact dimensioning of the individual linkages and joints, this method as well can lead to particularly rapid convergence of the iterative method. In general, it is also not absolutely necessary that a continuous or any fixed predetermined sequence is adhered to at all. Under certain circumstances, it can also be advantageous to jump back and forth between inner and outer joints in the sequence of a run of the loop. In addition, it is also possible and under certain circumstances advantageous to vary the sequence in different runs of the loop. For example, the sequence in a given run of the loop can be adapted to how great the changes in angle of the respective joints were in the previous run. It is also possible to skip certain joints in one run of the loop.

Prior to the iterative method described starting, it is generally advantageous to have the robotic arm be made to assume an initial state which, according to the information available about the system, comes as close as possible to the superordinate reference pose to be reached. Even if the exact absolute angular position of the individual articulated drives is not known or has only been calibrated imprecisely, at least estimated values can typically be determined for each angular position. The robotic arm can then be taken to an approximate target pose before running the iterative method, which can significantly accelerate the convergence of the method.

According to a particularly advantageous embodiment, either all existing robotic joints or all with the exception of the innermost and/or outermost robotic joint can be so-called “selected robotic joints”, which can be aligned in an automated manner within the iterative loop. The more of the existing joints that can be aligned as “selected joints” in an automated manner, the more completely the superordinate reference pose to be reached can be defined. In other words, the automated alignment can then include all the more rotational degrees of freedom. However, this is not always possible in practice, as is also evident in the context of the figures. For example, the innermost joint (which is closest to a base) can be fixedly mounted in a vertical installation position. With a rotation about this joint, no change in the torque acting in the joint drive is caused. Such a joint can therefore not be aligned in an automated manner using the method described. Instead, this joint must be aligned by way of angle calibration that is determined in another way. Even the outermost joint, which typically carries the end effector, may not be able to be aligned with the method described, or not so well, especially if the end effector has not yet been mounted or is very light and no eccentric lever element is therefore available or only low leverage is achieved. Finally, it can happen that other joints located therebetween are no “selected robotic joints” for the reason that they are, for example, likewise perpendicular in space in the superordinate reference pose and no variation in the torque due to gravity is then obtained when they are rotated. Here as well, either a different angle calibration can be resorted to, or the state with regard to such a joint is not determined in more detail when defining the superordinate reference pose. In other words, the degrees of freedom of the “unselected joints” then remain variable. Only the “selected joints” are then iteratively made to assume the vertically extended position.

Generally advantageously, the selected robotic joints can each have a rotary position sensor as part of the drive device for determining an angular position of the output member. These individual rotary position sensors can be calibrated in particular with a respective local angular reference position which is derived from the superordinate reference pose determined according to the invention. The rotary position sensors can be, for example, relatively referenced rotary position sensors which necessarily require calibration in order to determine an absolute angular position. Alternatively, it can also be an absolutely referenced rotary position sensor, for which, however, the exact installation position in the overall system is not known from the outset. Even with such absolutely referenced rotary position sensors, the method according to the invention can be used to calibrate the angle measurement with respect to the absolute position in space (i.e., relative to the gravitational vector).

Alternatively or additionally, the selected robotic joints can each have a torque measuring device as part of the drive device for measuring a torque acting within the drive device. This measuring device can comprise, for example, a spoked wheel as an essential part. The torque transmitted via the spoked wheel is measured from a deformation of the spokes. The deformation can be determined in particular using strain gauges. The torque measured can be in particular a gear support torque. The individual torque measuring devices can then be calibrated in particular by measuring the torque in the superordinate reference pose of the robotic arm. In other words, the torque of the respective joint is measured in the reversal position in which the torque caused by the associated lever element is in fact zero. A zero-point measurement for the calibration of the torque measuring device is thus carried out at this point. An offset of the torque measuring device can be corrected out in this manner.

In general, after reaching the superordinate reference pose, a selected robotic joint can be moved to an angular position in which the associated eccentric lever element causes a maximum torque. In other words, starting from the completely vertically extended reference pose, a defined joint can be bent by 90° to the horizontal position of the lever element. This means that a Γ-shaped pose is assumed with a bend in the one defined joint. The actuation of this pose can be achieved, for example, by a rotation which corresponds to a relative change in angle of 90° predetermined by the rotary position sensor. Alternatively, the actuation of this pose can also be achieved in that the maximum lever position is determined in an automated manner, in particular by measuring the current values, and it is thereafter assumed with respect to the one joint specified. Regardless of how the maximum lever position has been reached, it can in any case be used to carry out a further calibration of the associated torque measuring device in the given joint. With this additional measurement, the gain (i.e. a proportionality factor) of the torque measurement can also be determined in addition to the offset. In other words, complete calibration of the torque measuring device can thus be done.

In general, the entire alignment of the robotic arm in the superordinate reference pose can be repeated several times at intervals. The reference pose can serve as a so-called rest pose in which the robotic arm is parked as long as no other pose needs to be assumed. With the method according to the invention, this rest pose can be autonomously moved to again and again in a reproducible manner and with little effort.

In addition, by repeatedly assuming the rest pose, automated periodic recalibration of the rotary position sensors and/or torque measuring devices of the individual joints is made possible in a simple manner. Even if changes in the system arise during operation, such periodic calibration enables a precise absolute angular position to be determined over the long term. Such repeated calibration can in particular also be used to monitor incorrect settings of individual elements of the drive device. When calibrating a drive device in a robotic arm, misalignment of the individual robot links or robot joints occurring during operation can be recognized and corrected. A self-monitoring system can thus be implemented in a simple manner.

### BRIEF DESCRIPTION OF THE DRAWINGS

The invention shall be described hereafter by way of a few preferred embodiments with reference to the appended drawings, in which:

FIG. 1 shows a schematic perspective illustration of a robotic arm,

FIG. 2 shows a sequence of several poses of a simplified sketched two-axis robotic arm, and

FIG. 3 shows a sequence of several poses of a simplified sketched three-axis robotic arm.

### DETAILED DESCRIPTION OF THE PREFERRED EMBODIMENTS

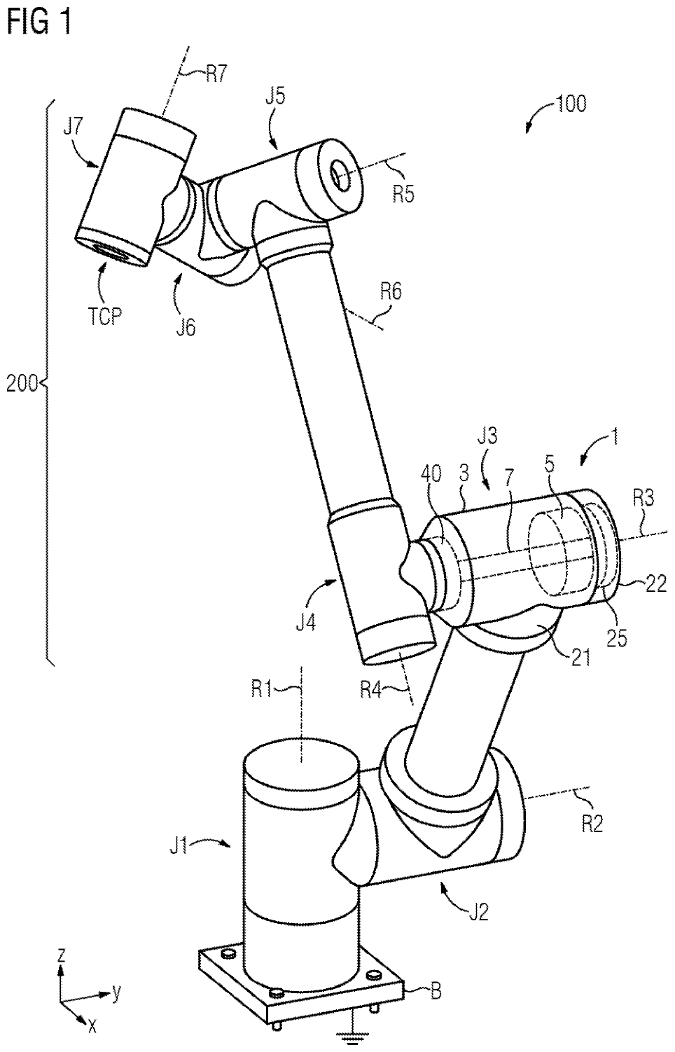

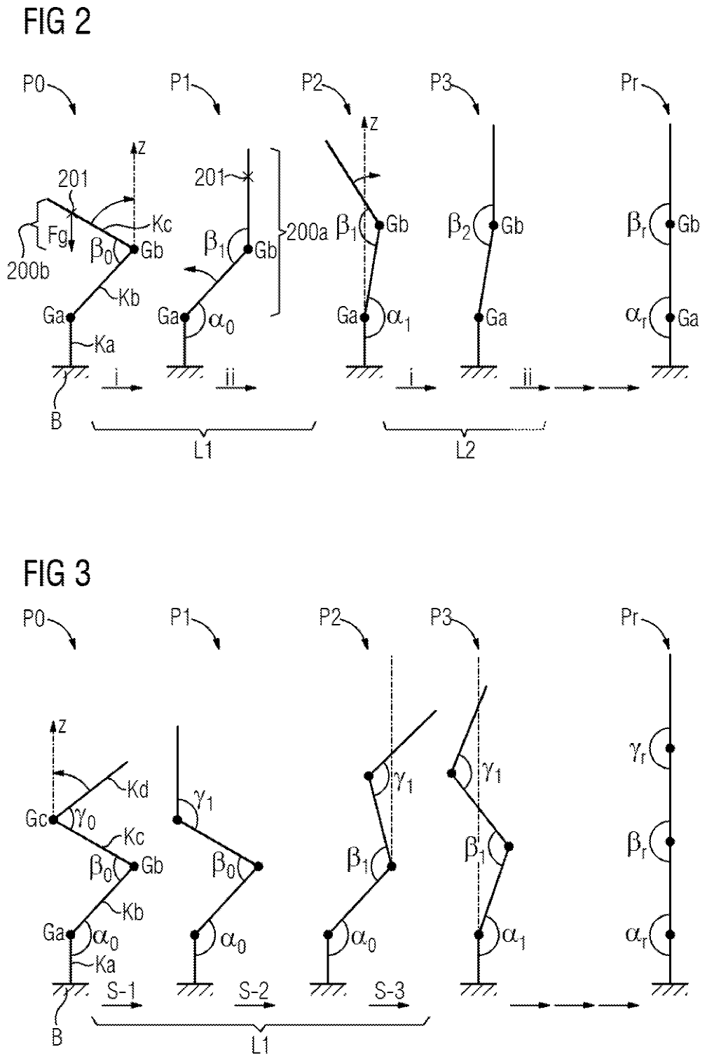

Same elements in the figures or those with the same function are denoted with the same reference characters. FIG. 1 shows a schematic perspective illustration of a robotic arm 100 which can be aligned using the method according to the invention. This is a robotic arm with seven robotic joints J1 to J7, each of which enables a rotation about an associated axis of rotation R1 to R7. This is therefore a robotic arm with seven rotational degrees of freedom. “Innermost” joint J1 is connected to a base B which serves as a superordinate mechanical mass. “Outermost” joint J7 can carry an end effector (not shown in detail) at location TCP. A drive device each is arranged within individual joints J1 to J7. These are rotary drives for rotating the individual joints, the basic structure of which and their mechanical mode of operation are known from prior art. Two or more of the rotary joints shown can be aligned with the method according to the invention. They are therefore referred to as “selected joints” in the context of the invention. A superordinate reference pose has been reached at least for these selected joints after having run through the method, as shall become more evident in the context of FIGS. 2 and 3.

The so-called selected joints are those with respect to which an eccentric lever element, which can develop an angle-dependent torque due to gravity, is formed with other partial elements of the robotic arm. The selected joints can therefore be made to assume a reversal position in an automated manner with respect to this lever using the method according to the invention. For this purpose, the associated axes of rotation should be able to be aligned with at least one horizontal directional component. Both requirements are presently fulfilled at least in terms of joints J2, J3 and J5: An eccentric lever arm is respectively formed by the more outer parts of the robotic arm, and the associated axis of rotation can assume a horizontal direction in a vertically extended pose (along the z-axis). A superordinate reference pose Pr can therefore be defined such that joints J2, J3 and J5 cause a vertical extension. The angular positions of remaining joints J1, J4, J6 and J7 can there either remain freely adjustable or made to assume a target position in some other way.

FIG. 1 serves as an example of how both “selected robotic joints”, which can be aligned in an automated manner using the method, as well as other joints can come together in a robotic arm 100. In principle, however, robotic arms 100 can also be implemented in which at least the majority of joints or even all of the joints are so-called selected joints. Joint J1 close to the base could in principle also be a selected joint, for example, if it were to be in a horizontal axial position due wall mounting or an L-shaped connection member on the base. The outermost joint (presently J7) could also be a selected joint, for example, if a tool were mounted at the tool center point (TCP) which would form an eccentric lever element. In principle, it would also be possible for all joints therebetween to be selected joints, for example, if the joint connections (i.e., the linkages) were shaped in such a way that all joints J2 to J6 could assume a horizontal axis position within the x-y plane or at least with a significant directional component in the x-y plane. For the illustrative examples for carrying out the method in FIGS. 2 and 3, respective robotic arms are therefore assumed in which all the joints present are implemented as “selected joints”.

The inner structure of joint J3 is sketched in somewhat greater detail in FIG. 1 By way of example as one of the “selected joints”: This robotic arm J3 comprises a drive device 1 which enables rotation about axis of rotation R3. In this example, drive device 1 comprises an electric drive machine 5 which in principle can be operated both in the motor mode as well as in the generator mode. The rotor of this drive machine is coupled to an output member 40 via a drive shaft 7 for transmitting torque. Also provided optionally in the region between drive machine 5 and output member 40 can be a gear (presently not shown) which translates the rotation and indirectly imparts the coupling. It is only essential that a rotation of machine 5 is transmitted to output member 40. The elements which are disposed further outwardly as seen from joint J3 together form an eccentric lever element 200. By rotating the output member, this lever element 200 can be made to assume an upper reversal position. This position can in particular be recognized by a zero-crossing of the machine current and assumed in an automated manner. For this purpose, a control device 25 is arranged, for example, in the region of end cap 22 of the joint and comprises a current sensor (presently not shown) and, in addition to the functionality of a control device, also covers the functionality of an evaluation device. Individual angular positions of the output member can then be actuated in an automated manner with this control device 25, and the zero run of the current curve (possibly with averaging the values for the forward and reverse directions) can also be determined in an automated manner.

FIG. 2 shows a sequence of several poses P0 to Pr of a simplified sketched robotic arm with two rotary joints Ga and Gb. Both joints are to be selected joints, the respective axis of rotation of which is perpendicular to the vertical z-direction. Joint Ga is the joint near the base and is connected to base B by a linkage Ka. The two joints are connected to one another by a linkage Kb. An external linkage Kc carries an end effector, presently not shown. P0 is the starting pose from which the superordinate reference pose has been reached in several iterative steps with the method according to the invention. In reference pose Pr, all linkages are extended vertically in the z-direction and angular positions α and β of the two joints are each (by definition) at 180°.

In order to reach this reference pose Pr, starting from the original pose P0, several changes in angle are performed in an iterative process in individual joints Ga and Gb. In the first run of loop L1, two sub-steps i) and ii) take place. In first sub-step i), for example, outer joint Gb is adjusted. The associated change in angle from 0 to 1 is carried out in an automated manner in such a way that associated eccentric lever element 200b is made to assume an upper reversal position. For outer joint Gb, eccentric lever element 200b is formed by outer linkage Kc. A gravitational force Fg acts at center of mass 201 of this lever element pulling the lever element downwardly and causing a torque in the region of joint Gb. In the first partial step, this lever element 200b is now made to assume an upper reversal position in an automated manner according to pose P1 in which the torque of the lever is zero This reversal position can be determined in particular by determining (and possibly averaging) zero-crossings of the machine current in the associated drive device. The robotic arm is made to assume pose P1 in an automated manner in which center of mass 201 of lever element 200b is located on the z-axis.

In second sub-step ii), a corresponding alignment is carried out for joint Ga disposed further inside: Associated eccentric lever element 200a is there formed by two linkages Kb and Kc and joint Gb located therebetween. In sub-step ii) inner joint Ga is moved in such a way that this entire lever element 200a comes to lie with its associated center of mass on the z-axis. The angular position in joint Ga is there changed from α₀ to α₁, and pose P2 has been reached. For the present example with only two selected joints Ga and Gb, the first run of loop L1 of the iterative process is completed. For the second run of loop L2, only first sub-step i) for pose P3 is only still indicated in FIG. 2: Here as well, similar to the very first motion, only lever element 200b is rotated with its center of gravity on the z-axis. As indicated by the further arrows, corresponding sub-step ii) follows for inner joint Gb and these sub-steps are alternately repeated in several further iterative loops until a termination criterion for the remaining changes in angle has been reached. At this point in the method, completely vertically extended reference pose Pr with the defined accuracy has been reached.

FIG. 3 shows an example of how the method described can be applied to a larger number of joints to be aligned in an automated manner. A simplified sketch of a robotic arm is shown with three selected rotary joints Ga, Gb and Gb, corresponding joint angles α, β, γ, and four linkages Ka, Kb, Kc and Kd which connect the joints to one another or to base B and the tool center point. Again, a first run of loop L1 is shown in which these three joints are aligned one after the other in an automated manner in three sub-steps s-1), s-2) and s-3). Here as well, a sequence from the outermost joint to the innermost joint is shown by way of example, although this is not mandatory. In each sub-step s-i), the relevant eccentric lever arm is made to assume the upper reversal position. Each of the joints is adjusted once during each loop. Similarly to the example in FIG. 2, the limit values for the changes in angle are also undercut after a certain number of runs of the loops, and reference pose Pr has been reached with the predefined accuracy.

### LIST OF REFERENCE CHARACTERS

1 drive device
3 drive housing
5 drive machine
7 drive shaft
21 elevated portion
22 end cap
25 control device (including evaluation device and current sensor)
40 output member (output shaft)
100 robotic arm
200 eccentric lever element
200a eccentric lever element for joint Ga
200b eccentric lever element for joint Gb
201 center of mass
B base of the robotic arm
Fg gravitational force
Ga selected robotic joint
Gb selected robotic joint
Gc selected robotic joint
α angle at selected robotic joint Ga
β angle at selected robotic joint Gb
γ angle at selected robotic joint Gc
i first sub-step
ii second sub-step
s-i step no. i
J1 first robotic joint with axis R1
J2 second robotic joint with axis R2
J3 third robotic joint with axis R3
J4 fourth robotic joint with axis R4
J5 six robotic joint with axis R6
J6 sixth robotic joint with axis R6
J7 seventh robotic joint with axis R7
Ka linkage
Kb linkage
Kc linkage
Kd linkage
L1 first run of the loop
L2 second run of the loop
Pi pose no. i
Pr reference pose (rest pose)
TCP end effector (tool center point)
x, y, z cartesian spatial directions

What is claimed is:

1. A method for aligning a robotic arm in a superordinate reference pose,
where said robotic arm comprises a plurality of robotic joints, each of which comprises a drive device which enables a rotation about an associated axis of rotation,
where an associated eccentric lever element is formed for at least two selected robotic joints by one or more other partial elements of said robotic arm,
said method comprising the sub-steps of:
i) aligning said drive device of a first selected robotic joint in an automated manner in a first target position in which the associated first eccentric lever element is disposed in a reversal position
ii) aligning said drive device of a second selected robotic joint in an automated manner in a second target position in which the associated second eccentric lever element is disposed in a reversal position,
where sub-steps i) and ii) are repeated one after the other in an iterative loop until the change in angle effected in each sub-step falls below a predetermined limit value.

2. The method according to claim 1, in which said drive devices of said at least two selected robotic joints each
comprise an electric drive machine,
comprise an output member which is rotatable relative to the associated axis of rotation by way of said drive machine,
comprise a current sensor for measuring an operating current flowing within said electric drive machine,
and where said automated alignment in the first target position can be effected for each of said drive devices by the following sub-steps
a) successively moving to a plurality of predetermined angular positions of said output member,
measuring an associated current value for each predetermined angular position by way of said current sensor,
b) determining a target position from the pair of values thus determined, such that the associated current value of the target position comes as close as possible to a zero-crossing.

3. The method according to claim 2, in which step a) comprises the following sub-steps:
a1) successively actuating a first sequence of predetermined angular positions such that said output member is continuously rotated in a fixed first direction of rotation,
a2) successively actuating a second sequence of predetermined angular positions such that said output member is continuously rotated in an oppositely directed second direction of rotation,
and where in step c), a first reference angle is determined from the pairs of values of the first sequence determined, and a second reference angle is determined from the pairs of values of the second sequence determined,
a superordinate target position is determined by averaging said first and said second reference angles.

4. The method according to claim 1, where the total number of robotic joints is between 3 and 7.

5. The method according to claim 1, in which an associated eccentric lever element is formed for a number n of three or four selected robotic joints by one or more other partial elements of said robotic arm,
where the method comprises an iterative loop in which the following sub-step is carried out in each run of the loop one after the other for all n selected robotic joints:
s-i) aligning said drive device of said respective selected robotic joint in an automated manner in an associated target position in which said associated eccentric lever element is disposed in a reversal position,
where the loop is to be run until the change in angle effected in each sub-step falls below a predetermined limit value.

6. The method according to claim 1, in which the sequence in each run of the iterative loop in which said individual selected robotic joints are aligned runs continuously from the outside to the inside.

7. The method according to claim 1, in which the sequence in each run of the iterative loop in which said individual selected robotic joints are aligned runs continuously from the inside to the outside.

8. The method according to claim 1, in which either all existing robotic joints or all with the exception of the innermost and/or outermost robotic joints are selected robotic joints which are aligned in an automated manner within the iterative loop.

9. The method according to claim 1, in which said selected robotic joints each comprise a rotary position sensor as part of said drive device for determining an angular position of said output member.

10. The method according to claim 9, in which said individual rotary position sensors are calibrated with the local angular reference position derived from said superordinate reference pose of said robotic arm.

11. The method according to claim 1, in which said selected robotic joints each comprise a torque measuring device as part of said drive device for measuring a torque acting within said drive device.

12. The method according to claim 11, in which said individual torque measuring devices are calibrated by measuring the torque in said superordinate reference pose of said robotic arm.

13. The method according to claim 1, in which, after reaching said superordinate reference pose, a selected robotic joint is moved to an angular position in which said associated eccentric lever element causes a maximum torque.

14. The method according to claim 1, in which the entire alignment of said robotic arm in said superordinate reference pose is repeated several times at intervals.

15. The method according to claim 14, in which the repeated alignment of said robotic arm in said superordinate reference pose is used to monitor incorrect settings of individual elements of said robotic arm.
